(19) United States
(12) Patent Application Publication
(10) Pub. No.: US 2005/0154822 A1
(43) Pub. Date: Jul. 14, 2005

(54) Multi-control data table compression method and optical disk drive using the same

(75) Inventor: Ki-ju Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/028,678

(22) Filed: Jan. 5, 2005

(30) Foreign Application Priority Data
Jan. 9, 2004 (KR) 2004-1413

(51) Int. Cl. G06F 12/00

(52) U.S. Cl. 711/112; 711/170

(57) ABSTRACT

Provided are a multi-control data table compression method of compressing a plurality of control data tables of a disk drive and an optical disk drive using the same. The multi-control data table compression method of compressing a plurality of control data tables of a disk drive includes grouping the control data tables according to disk type according to a classifying standard, compressing the control data tables by groups according to a compressing standard, and generating the compressed control data tables.

### CROSS-REFERENCE TO RELATED APPLICATION

This application claims the priority of Korean Patent Application No. 2004-1413, filed on Jan. 9, 2004, in the Korean Intellectual Property Office, the disclosure of which is incorporated herein by reference.

### BACKGROUND OF THE INVENTION

1. Field of the Invention

The invention relates to an optical disk drive design method and apparatus, and more particularly, to a multi-control data table compression method of reducing a flash memory volume by producing compact control data tables according to disk types, and an optical disk drive using the same.

2. Description of the Related Art

In general, optical discs are classified as read only optical discs, such as compact disc-read only memory (CD-ROM), write-once optical discs that can be written to only once, such as a compact disc-recordable (CD-R), and rewritable optical discs, such as a compact disc-rewritable (CD-RW). Due to the development of large volume disks, such as digital versatile disks (“DVD”), optical discs are being used for recording PC data, as well as various video and audio data. However, the recording/reproducing characteristics of the optical discs are different according to disk types, manufacturing specifications of manufacturers, and disk speeds.

Accordingly, when an optical disk drive is designed, control data tables for disk identifications (“IDs”) are designed and stored in a flash memory so that the optical disk drive optimally performs according to disk types, manufacturing specifications, and multiple speeds.

Thus, since control data tables, including a disk type, manufacturing specifications, and a speed for each disk ID, are stored in a flash memory of an optical disk drive, additional memory usage is required. Accordingly, when there is a large amount of control data, the disk drive takes a long time to search the control data.

### SUMMARY OF THE INVENTION

The invention provides a multi-control data table compression method of minimizing the amount of memory usage for an optical disk drive by grouping a plurality of control data tables according to disk specifications, compressing control data into disk groups, and storing the compressed control data in a flash memory, and an optical disk drive using the same.

According to an aspect of the invention, there is provided a multi-control data table compression method of compressing a plurality of control data tables determining performance of a disk drive, the method including grouping the control data tables according to disk type according to a predetermined classifying standard, compressing the control data tables by groups according to a predetermined compressing standard, and generating the compressed control data tables.

According to another aspect of the invention, there is provided an optical disk drive including a flash memory storing a plurality of control data tables compressed into groups according to a predetermined compressing standard after the control data tables are grouped according to a predetermined classifying standard, the control data tables determining how the disk drive performs according to disk type, a plurality of optical detectors detecting light reflected from a disc, a signal processing circuit generating a servo control signal and a signal processing signal based on signals detected by the optical detectors and restoring data by processing the signal processing signal; and a system controller controlling the optical disk drive so as to receive the servo control signal and the restored data from the signal processing circuit, identify a type and ID of the disc, read from the flash memory a compressed control data table from a group corresponding to the identified type and ID of the disc, decompress the compressed control data table, and set relevant parameter values using the decompressed control data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an optical disk drive according to an embodiment of the invention;

FIG. 2 is a flowchart of a multi-control data table compression method according to an embodiment of the invention;

FIG. 3 is a flowchart of a method of decompressing compressed multi-control data stored in a flash memory according to an embodiment of the invention; and

FIG. 4 illustrates a control data table according to an embodiment of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

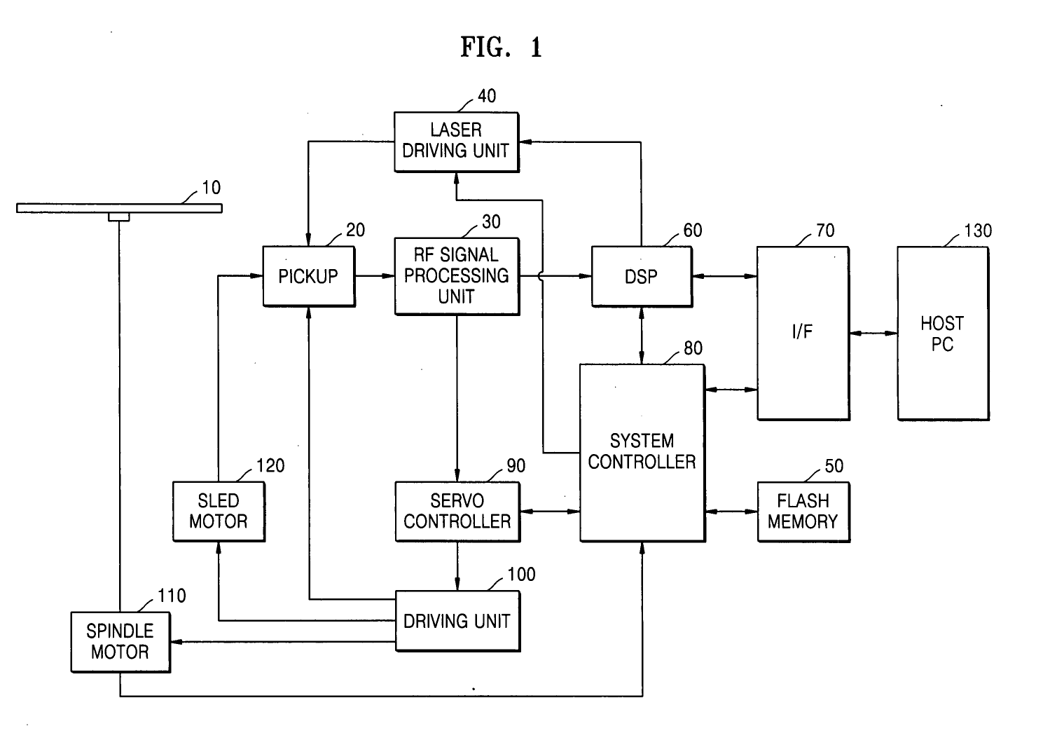

FIG. 1 is a block diagram of an optical disk drive according to an embodiment of the invention.

Referring to FIG. 1, an optical disk drive includes a pickup 20, an RF signal processing unit 30, a laser driving unit 40, a flash memory 50, a digital signal processor (DSP) 60, an interface (I/F) circuit 70, a system controller 80, a servo controller 90, a driving unit 100, a spindle motor 110, and a sled motor 120.

For example, a circuit including the RF signal processing unit 30, the DSP 60, and the I/F circuit 70 may be referred to as a signal processing circuit.

The pickup 20, which includes a laser diode (not shown), a plurality of photo diodes (not shown), a lens (not shown), and a focus/tracking actuator (not shown) for moving the lens in a vertical/horizontal direction, emits light onto a disk 10 and detects an optical signal reflected from the disk 10.

The RF signal processing unit 30 generates focus/tracking error signals for servo control by calculating, or determining, optical signals detected by the plurality of photo diodes of the pickup 20. The RF signal processing unit 30 may also generate a signal for signal processing. The RF signal processing unit 30 may additionally filter and equalize the signal for signal processing and convert the equalized signal into a binary signal. The RF signal processing unit may additionally output the binary signal to the DSP 60.

According to an aspect of the invention, laser driving unit 40 outputs a laser driving signal, in response to an input signal, in a write mode, and a driving signal, generating a predetermined intensity of laser beam, in a read mode. For example, in the write mode, the laser driving unit 40 varies the intensity and the width of the laser beam according to control data values stored in a write strategy table, corresponding to the specification and multiple speed of the disk 10.

The DSP 60 may restore original data from the binary signal input from the RF signal processing unit 30 using a phase synchronized system clock when the laser driving unit 40 is in the read mode. When the laser driving unit 40 is in the write mode, the DSP 60 may convert data converted into a write format into a bit stream and output the bit stream to the laser driving unit 40.

The servo controller 90 may generate a tracking/focus actuator driving voltage for controlling the horizontal and/or vertical position of the lens installed in the pickup 20 according the tracking or focusing error signal. When the disk drive is in a seek mode, the servo controller 90 may generate a driving voltage, which is applied to the sled motor 120 to move or position the pickup 20 to a target track. The servo controller 90 may additionally generate a spindle motor driving voltage to drive the spindle motor 110 according to a spindle motor target rotating speed corresponding to the multiple speed determined by the system controller 80.

The driving unit 100 drives the spindle motor 110 and the sled motor 120. For example, the driving unit 100 generates driving currents for driving the spindle motor 110 and the sled motor 120 according to the driving voltage generated by the servo controller 90. The driving unit 100 may also generate a focus/tracking actuator driving current for controlling focus and/or tracking of the lens of the pickup 20.

The I/F circuit 70 performs data interfacing for transmitting/receiving data with a host computer 130.

The flash memory 50 stores a plurality of compressed control data tables. For example, the flash memory 50 stores a plurality of control data tables compressed by groups using a compression standard after the plurality of control data tables, which determine the performance of a disk drive according to disk types, are grouped using a design classifying standard. The compressing standard for compressing groups is a predetermined compressing standard.

For example, in the design classifying standard, the control data tables may be classified according to disk manufacturers. The compression standard may additionally detect how many times control data values of each parameter included in the plurality of control data tables are consecutively repeated and generate control data compressed into a control data value and a value indicating the number of times that the control data value is repeated.

According to an aspect of the invention, the control data table includes a write strategy table related to recording, or writing, to the disk.

For example, the write strategy table is organized such that a disk drive has an optimal write performance when using control data according to disk types and multiple speeds. Accordingly, the write strategy table includes control data for determining intensity and width of the laser beam according to an optimal recording power designated for differing disk type specifications and multiple speeds of disks.

The system controller 80 controls an optical disk drive. For example, the system controller 80 controls the optical disk drive to receive the servo control signal and the restored data from the signal processing circuit, identifies a type and ID of a loaded disc, reads a compressed control data table from a group corresponding to the specification of the identified disk from the flash memory 50, decompresses the compressed control data table, and/or sets relevant parameter values according to the decompressed control data.

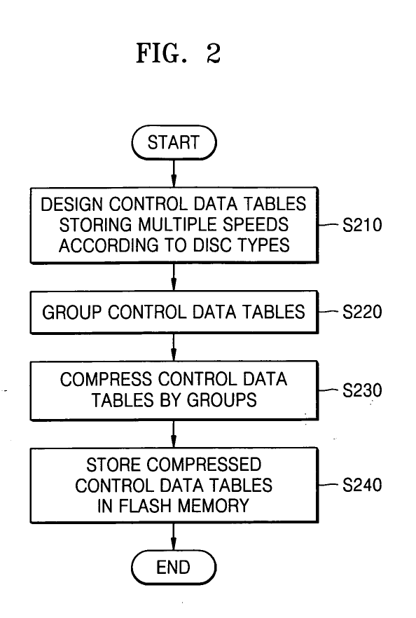

FIG. 2 is a flowchart of a multi-control data table compression method according to an embodiment of the invention. For example, as shown in operation 210, control data tables are designed to determine parameters or control data values for a disk drive to perform, according to a variety of speeds and disk IDs.

The control data tables may be grouped according to a classifying standard, as shown in operation 220. For example, to efficiently perform data compression, the control data tables may be grouped according to disk manufacturers. The classifying standard for classifying the control tables is a predetermined classifying system.

The control data tables classified into groups may be compressed using data regularity information, as shown in operation 230.

According to the compression standard used in this embodiment, the number of control data values consecutively repeated with respect to each control data included in the plurality of control data tables in a single group is detected, the control data is compressed into a control data value, and the number of times that the control data is repeated is generated.

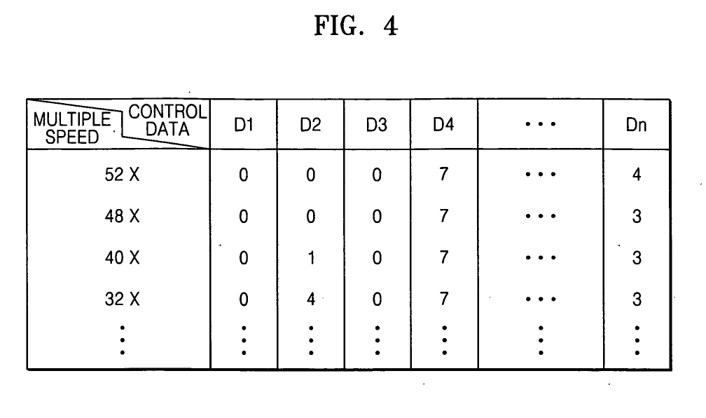

For example, when a control data table, as shown in FIG. 4, is compressed, when each of the first 30 values of the control data D1 is “0” regardless of multiple speeds, the corresponding compressed control data is generated as D1₍₁₎ [0, 30]. Additionally, when each of 31^{st} through 36^{th} values of the control data D1 is “1”, the corresponding compressed control data is generated as D1₍₂₎ [1, 6].

Therefore, for example, every compressed control datum has 2 bytes. The first byte may be a control data value and the second byte may be the number of times that the control data value is repeated, or vice-versa.

The compressed control data tables may be stored in the flash memory 50, as shown in operation S240.

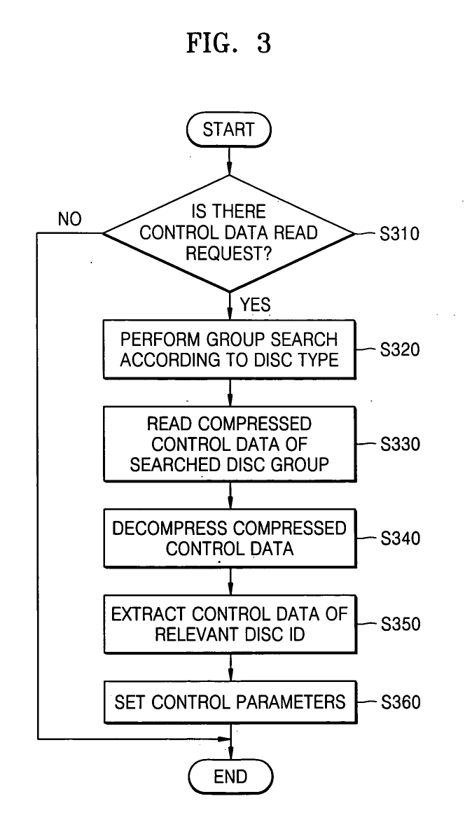

FIG. 3 is a flowchart of a method of decompressing the compressed multi-control data stored in the flash memory 50 according to an aspect of the invention. Referring to FIG. 3, as shown in operation 310, an optical disk drive determines whether a request for reading control data stored in the flash memory 50 is generated. For example, when a write command is received after an optical disk is loaded in the optical disk drive, a request for reading control data from a write strategy table is generated to determine parameters related to recording performance of the disk depending on the type and available multiple speeds of the disk.

For example, as shown in operations 320 and 330, when the control data read request is generated, a disk ID recorded on the optical disk loaded in the optical disk drive is read, and a compressed control data table of a disk group of which the disk ID is stored is searched and read from the flash memory 50.

The compressed control data table may then be decompressed, as shown in operation 340.

Only control data corresponding to the write speed of the disk ID may be extracted from the decompressed control data table, as shown in operation 350.

Parameters relating to the recording performance of the disk may be set using the extracted control data, as shown in operation 360.

For example, the decompressing method enables the parameter values to be determined using control data values by decompressing a compressed control data table.

As described above, according to embodiments of the invention, the amount of flash memory required for a disk drive may be reduced by classifying a plurality of control data tables into groups according to disk specifications, compressing the plurality of control data tables according to disk types, storing the compressed control data tables in a flash memory, and decompressing the compressed control data tables to set parameters. Additionally, since the size of the control data is relatively small, a search time may be reduced.

The invention may be realized as a method, an apparatus, and/or a system. For example, when the invention is realized as software or computer readable code, components of the invention are embodied as code segments for executing required operations. A program or the code segments can be stored in a processor readable recording medium and/or transmitted as computer data signals combined with a carrier using a transmission medium or a communication network. The processor readable recording medium is any data storage device that can store and/or transmit data, which can be thereafter read by a computer system. For example, the processor readable recording medium may include electronic circuits, semiconductor memory devices, read-only memory (ROM), flash memory, erasable ROM, floppy disks, optical discs, hard discs, optical fiber media, and RF networks. In addition, the computer data signals may include any signal that can be propagated via transmission media such as electronic network channels, optical fibers, air, electronic fields, RF networks.

Although a few embodiments of the present invention have been shown and described, it would be appreciated by those skilled in the art that changes may be made in these embodiments without departing from the principles and spirit of the invention, the scope of which is defined in the claims and their equivalents.

1. A multi-control data table compression method of compressing control data tables that identify performance of a disk drive, the method comprising:
grouping the control data tables according to disk types via a classifying standard; and
compressing the grouped control data tables via a compression standard.

2. The multi-control data table compression method of claim 1, further comprising:
generating the compressed control data tables.

3. The multi-control data table compression method of claim 1, wherein the classifying standard comprises:
grouping the control data tables according to disk type manufacturers.

4. The multi-control data table compression method of claim 1, wherein the control data table comprises:
a write strategy table to determine parameters related to recording performance of a disk.

5. The multi-control data table compression method of claim 1, wherein the control data is classified according to disk speeds.

6. The multi-control data table compression method of claim 1, wherein according to the compressing standard, a number of times that control data values of each parameter included in the control data tables is consecutively repeated is detected and control data, which includes a control data value and the number of times that control data is repeated, is generated.

7. An optical disk drive comprising:
a flash memory storing a plurality of control data tables classified into groups according to a classifying standard and compressed into groups according to a compression standard to determine disk drive performance according to types of media operable with the optical disk drive;
a plurality of optical detectors detecting light reflected from a medium;
a signal processing circuit generating a servo control signal and a signal processing signal according to signals detected by the optical detectors, and restoring data by processing the signal processing signal; and
a system controller controlling the optical disk drive to receive the servo control signal and the restored data from the signal processing circuit, identify a type and identification of the medium, read from the flash memory a compressed control data table from a group corresponding to the identified type and identification of the medium, decompress the compressed control data table, and set relevant parameter values of the optical disk drive using the decompressed control data.

8. The optical disk drive of claim 7, wherein according to the classifying standard, the control data tables are grouped according to media manufacturers.

9. The optical disk drive of claim 7, wherein the control data table includes a write strategy table related to recording to the medium.

10. The optical disk drive of claim 7, wherein the control data is classified according to speeds of the media.

11. The optical disk drive of claim 7, wherein according to the compression standard, a number of times control data values of each parameter included in control data tables is consecutively repeated is detected, and control data, including a control data value and the number of times that control data is repeated, is generated.

12. The optical disk drive of claim 7, wherein the plurality of control data tables are classified into groups according to the classifying standard and then compressed into groups according to the compression standard to determine disk drive performance according to a corresponding type of media.

13. A flash memory device of a disk drive storing data relating to disk drive performance parameters corresponding to recording and/or reproducing characteristic data of media to be read by the disk drive, comprising:
a plurality of control tables relating to characteristic data of media to be read by the disk drive such that at least one of the plurality of control tables has disk drive performance parameters corresponding with a medium read by the disk drive,
wherein control tables are grouped according to a predetermined classification and compressed according to a multi-control table compression standard.

14. The flash memory device of claim 13, wherein the disk drive performance parameters are set by decompressing the compressed control tables and extracting corresponding control data from the decompressed control tables.

15. The flash memory device of claim 13, wherein the compressed control tables comprise compressed data having at least a control data value and a value indicating a number of times that the control data value is repeated.

16. The flash memory device of claim 15, wherein the compressed data is two bytes of data, such that a first byte of the compressed data is the control data value and a second byte of the compressed data is the value indicating the number of times that the control data value is repeated.

17. The flash memory device of claim 13, wherein the control table further comprises:
a write strategy related to writing information to the medium, such that the disk drive has a write performance corresponding with at least one of a plurality of characteristic data of the medium.

18. The flash memory device of claim 13, further comprising:
a controller controlling the optical disk drive to read from the flash memory a compressed control table from a group corresponding to the medium, decompress the compressed control table, and set relevant parameter values using data from the decompressed control table.

19. A method of setting performance parameters for recording and/or reproducing data to and/or from a medium, comprising:
storing control tables, which determine performance of a disk drive according to a plurality of media, in a flash memory device;
grouping the control tables into groups according to characteristic data of the plurality of media;
compressing the control tables according to a multi-control table compression standard; and
decompressing a control table corresponding with a medium read by the disk drive to set disk drive performance parameters for recording and/or reproducing data to and/or from the medium.

20. The method of storing data of claim 19, further comprising:
grouping the control tables according to a predetermined classification; and
compressing the control tables according to a multi-control table compression standard,
wherein the disk drive operates according to the characteristic data of the medium.

21. The method of storing data of claim 19, wherein the decompressing comprises:
searching the grouped control tables according to at least one characteristic data of the medium to determine a grouped control table corresponding with the medium;
reading compressed control data of the corresponding grouped control table;
decompressing the compressed control data; and
extracting data corresponding to a write speed for the medium from the decompressed control table.

22. The method of storing data of claim 21, further comprising:
setting parameters relating to the recording performance of the medium according to the extracted control data.

23. The method of storing data of claim 19, wherein the compressed control tables comprise compressed data having at least a control data value and a value indicating a number of times that the control data value is repeated.

24. The method of storing data of claim 23, wherein the compressed data is two bytes of data, such that a first byte of the compressed data is the control data value and a second byte of the compressed data is the value indicating the number of times that the control data value is repeated.

25. A medium having computer readable code controlling a performance of the method of claim 19.

26. A multi-control data table compression method of compressing control data tables that identify performance of a disk drive, the method comprising:
grouping the control data tables according to disk types via a classifying standard;
compressing the grouped control data tables via a compression standard; and
generating the compressed control data tables,
wherein according to the compressing standard, a number of times that control data values of each parameter included in the control data tables is consecutively repeated is detected and control data, which includes a control data value and the number of times that control data is repeated, is generated.

27. An optical disk drive comprising:
a flash memory storing a plurality of control data tables classified into groups according to a classifying standard and compressed into groups according to a compression standard to determine disk drive performance according to types of media operable with the optical disk drive;
a plurality of optical detectors detecting light reflected from a medium;
a signal processing circuit generating a servo control signal and a signal processing signal according to signals detected by the optical detectors, and restoring data by processing the signal processing signal; and
a system controller controlling the optical disk drive to receive the servo control signal and the restored data from the signal processing circuit, identify a type and identification of the medium, read from the flash memory a compressed control data table from a group corresponding to the identified type and identification of the medium, decompress the compressed control data table, and set relevant parameter values of the optical disk drive using the decompressed control data,
wherein according to the compression standard, a number of times control data values of each parameter included in control data tables is consecutively repeated is detected, and control data, including a control data value and the number of times that control data is repeated, is generated.
